(19) United States
(12) Patent Application Publication
(10) Pub. No.: US 2003/0156921 A1
(43) Pub. Date: Aug. 21, 2003

(54) Bolt and method for manufacturing the bolt

(76) Inventors: Masato Nagawa, Fukuoka (JP); Hideki Noda, Fukuoka (JP); Hiromasa Tanaka, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/258,743

(22) PCT Filed: Mar. 26, 2001
(86) PCT No.: PCT/JP01/02426

(51) Int. Cl. F16B 35/04

(52) U.S. Cl. 411/411

(57) ABSTRACT

A bolt according to the invention comprises: a coarse screw thread portion of pitch P, which is formed from the tip end portion of a bolt shank to a prescribed portion; and a fine screw thread portion of pitch p (p=P/n wherein n is an integer of 2 or more), which is formed so as to overlap the coarse screw thread portion for at least the entire length of the coarse screw thread portion of the bolt shank or from the tip end portion to the prescribed portion of the coarse screw thread portion. And, it is an object of the invention to provide a bolt that can be mass-produced at low cost, bring about excellent synchronicity, strength against compression and shear, and an excellent tightening force, and in which a nut screwed therein is scarcely loosened upon receiving a large vibration load.

### FIELD OF THE INVENTION

The present invention relates to a bolt, having a loosening-preventing feature, which is provided with a coarse screw thread portion and a fine screw thread portion, and a method for manufacturing the bolt.

### PRIOR ARTS OF THE INVENTION

Recently, various types of bolts having loosening-preventing features, and methods for manufacturing the same have been researched and developed.

For example, Japanese Unexamined Patent Publication No. 51033 of 1999 (hereinafter called Publication “a”), which is one of the conventional arts, discloses ┌a self-locking screw having a slit, which separates flanks at both sides of a screw thread, provided along the ridge of a screw thread, and formed as a wide bottom recess portion by which the vicinity of the root bottom of the screw thread is curved inwardly from the extension face of a flank ┘.

Also, Japanese Unexamined Patent Publication No. 254072 of 1999 (hereinafter called Publication “b”), which is also one of the conventional arts, discloses ┌method for rolling a right screw thread and a left screw thread comprising the steps of: forming a plan-shaped screw thread (ridge), in which a right screw thread and a left screw thread crossing each other are developed in plan, on the surface of a plate; inserting a columnar material between a pair of plates opposed to each other in parallel with the surface turned inward; moving at least one of the plates while nipping the corresponding columnar material therebetween, and threading a right screw thread and a left screw thread crossing each other on the outer-circumferential face of said columnar material ┘.

However, the conventional art bolt and method for manufacturing the same have the following shortcomings and problems.

(1) In the art described in Publication “a”, since a slit is formed along the ridge of a screw thread, and the vicinity of the root bottom of the ridge is curved, the screw thread is made thin, wherein such problems as a deficiency in shearing stress and durability of use remain.

(2) In the art described in Publication “a”, since the screw thread is in a resiliently deformed state when a nut is tightened, the mechanical strength is decreased as time elapses. Therefore, another problem occurs in that the compression stress is deficient, and at the same time, durability is deficient. Further, safety is worsened.

(3) In the art described in Publication “b”, no consideration is taken in regard to the relationship of durability and strength of a screw thread portion and synchronism, etc., which are manufactured by a difference in the size of the pitches of a right screw thread and a left screw thread. Therefore, a root of one screw thread is unintentionally threaded with respect to the ridge of another screw thread, wherein the screw thread (ridge) may be crumbled to decrease the compression stress and shearing force. Accordingly, durability and tightening force thereof are lowered. Also, the synchronism of ridges of the right and left screw threads thus manufactured is corrupted, the screw thread (ridge) is subjected to a number of segmented parts, wherein the mechanical strength is lowered. Further, such a problem occurs in that it is difficult to visually detect defectives in screw thread products.

(4) In a case where the lead angle of a screw thread portion screwed in the first nut, which is first mounted in a bolt is smaller than the lead angle of a screw thread portion screwed in the second nut, which is mounted therein later, the distance in movement of the second nut is larger than that of the first nut with respect to turning at the same angle, such a problem is brought about in that these nuts are liable to be loosened, and become deficient in tightening force, whereby safety is deficient.

(5) A fine screw thread portion is irregularly formed on a coarse screw thread portion by merely making the pitch of the fine screw thread portion smaller than that of the coarse screw thread portion, and there occurs a part where a screw thread (ridge) of the coarse screw thread portion is remarkably cut off, wherein no regularity is secured in the pattern of the fine screw thread portion, which is formed so as to overlap as per pitch of the coarse screw thread portion, and a wave pattern appears on the outer diameter of a bolt, wherein such a bolt is unsatisfactory as a product. A high screw thread (ridge) and a low screw thread (ridge) are manufactured, wherein the loss in mechanical strength is understood to be larger than that of the standard screw threads.

The present invention solves the above-described problems and shortcomings inherent in the conventional arts, and it is therefore an object of the invention to provide a bolt that can be mass-produced at low cost, is excellent in synchronism of screw threads and excellent in compression strength and shearing strength, and can bring about excellent tightening force, and with which a nut screwed therein is not loosened upon receiving a large vibration load, and a method for manufacturing the bolt, which is capable of mass-production at low cost, bolts that have excellent mechanism strength and tightening force, and are not loosened even upon receiving a large vibration load at all times.

### DISCLOSURE OF THE INVENTION

In order to solve the above-described object, a bolt and a method for manufacturing the same according to the invention have the following constructions.

A bolt according to the first aspect of the invention is composed of a coarse screw thread portion of pitch P, which is formed from the tip end portion of a bolt shank to a prescribed portion, and a fine screw thread portion of pitch p (p=P/n wherein n is an integer of 2 or more), which is formed so as to overlap the above-described coarse screw thread portion for at least the entire length of the coarse screw thread portion of the above-described bolt shank or from the tip end portion to the prescribed portion of the coarse screw thread portion.

With such a construction, the following actions can be brought about.

(1) Since the pitch P of the coarse screw thread portion becomes equivalent to integral number times of 2 or more of the pitch p of the fine screw thread portion, the same pattern of the fine screw thread portion is formed per ridge of the coarse screw thread portion, and periodicity due to repetition of the pattern is secured, wherein, since parts reduced by formation of the fine screw thread portion at the ridges of the coarse screw thread portion periodically exist, it is possible to effectively prevent the mechanical strength from being lowered due to local thinning of the ridges of the coarse screw thread portion and the stress from being concentrated due to irregular formation of root portions of the fine screw thread portion on the ridges of the coarse screw thread portion, whereby durability of the bolt can be maintained.

(2) A fine nut can be screwed in the fine screw thread portion so as to overlap the coarse nut after a coarse nut is screwed in the coarse screw thread portion of the bolt, whereby the bolt and both the nuts can be tightened. At this time, if the fine nut and coarse nut are turned together, a repulsion force and a friction force operate on the contacting face (bearing surface) between both nuts since the pitch of the fine nut differs from that of the coarse nut, and backlash is corrected, wherein the coarse nut can be prevented from turning in its loosening direction. Reliability in the equipment to which the bolt is applied can be increased.

(3) Since a recessed and projected pattern having periodicity is formed at the screw thread portion of a bolt, the production can be facilitated and the yield ratio is high. Also, since it is possible to carry out visual checks with respect to defective bolts by observing the pattern and to simply judge the periodicity by analyzing a bolt image picked up by a television camera, etc., quality control can be facilitated, and it is possible to mass-produce high-quality bolts at low cost.

(4) Since the root portions (parts cut off when the root portions of the fine screw thread portion are formed in the ridges of the coarse screw thread portion) of the fine screw thread portion at the ridges of the coarse screw thread portion regularly exist in the axial direction of the bolt shank, the bolt has excellent appearance, and visual inspection can be easily carried out, wherein the commercial value of bolts can be increased.

(5) Since the root portions of the fine screw thread portion at the ridges of the coarse screw thread portion regularly exist in the axial direction of the bolt shank, pressure can be uniformly applied when tightening the bolt with nuts, wherein the ridges are free from being crumbled or chipped, and operating convenience can be secured since tightening and removing operations can be smoothly carried out.

Herein, a hexagonal bolt, square bolt, eye bolt, round-headed bolt having a square root, flush bolt, wing bolt, anchor bolt, hexagonal socket-headed bolt, etc., are used as bolts having a head portion, and a stud bolt, U bolt, etc., are used as bolts having a screw thread portion at both ends but not having any head portion.

In addition, the number of starts (threads) of coarse screw thread portions and fine screw thread portions may be singular or a plurality. Wherein the number of starts of the fine screw thread portion is less than or including the number of starts of the coarse screw thread portion, the lead angle of the fine screw thread portion becomes smaller than the lead angle of the coarse screw thread portion. Then, it is preferable that, where a fine nut is screwed in the fine screw thread portion after a coarse nut is screwed in the coarse thread portion, the coarse nut is prevented by the fine nut from turning in the loosening direction at all times, and is scarcely loosened.

A triangular screw thread, trapezoidal screw thread, square screw thread, serrated screw thread, and round screw thread may be listed as the sectional shape of the screw thread (ridge) of a screw thread portion.

The bolt according to the second aspect of the invention is a bolt as set forth in the first aspect and has a construction in which the above-described pitch p of the above-described fine screw thread portion is one half the above-described pitch P of the above-described coarse screw thread portion.

With such a construction, the following actions can be brought about in addition to the actions described with respect to the first aspect of the invention.

(1) In comparison with a case where the pitch p of the fine screw thread portion is less than ½ times (for example, ⅓ times or ¼ times) the pitch P of the coarse screw thread portion, it is possible to increase the surface area of a female screw thread portion of a fine nut, which is brought into contact with a male screw thread portion of a fine screw thread portion when the fine nut is screwed in the fine screw thread portion, whereby it is possible to maintain a tightening force between the fine screw thread portion and the fine nut at a high level, and at the same time, since the number of roots of the fine screw thread portion are a few, tightening and removing operations thereof can be smoothly carried out, and excellent workability can be secured.

The bolt according to the third aspect of the invention is a bolt as set forth in the first or second aspect of the invention, and has a construction in which the lead angle β of the above-described fine screw thread portion is smaller than the lead angle α of the above-described coarse screw thread portion.

With such a construction, the following actions can be brought about in addition to the actions described in the first aspect or second aspect of the invention.

(1) Since the lead angle β of the fine screw thread portion is smaller than the lead angle α of the coarse screw thread portion where a fine nut is screwed in a fine screw thread portion after a coarse nut is screwed in a coarse screw thread portion, the movement distance of the fine nut with respect to the same turning angle is made smaller than that of the coarse nut. Therefore, even if the coarse nut is turned in the loosening direction and is about to be separated from a member to be tightened, the fine nut cannot move over the movement distance of the coarse nut with the same turning angle, wherein the coarse nut is prevented by the fine nut from being turned in the loosening direction, and is scarcely loosened.

The bolt according to the fourth aspect of the invention is a bolt as set forth in any one of the first through third aspect of the invention, and has a construction in which the root diameter D (the diameter of a hypothetical cylinder brought into contact with the root bottom coaxially with the above-described bolt shank) of the above-described coarse screw thread portion is smaller than the root diameter d of the above-described fine screw thread portion.

With such a construction, the following actions can be brought about in addition to those described in any one of the first through third aspect of the invention.

(1) Since the root bottom portion (part where the ridge of the coarse screw thread portion is cut off) of the fine screw thread portion is shallow, and the reducing amount of the ridge of the coarse screw thread portion is slight even if the root bottom portion of the fine screw thread portion overlaps the ridge of the coarse screw thread portion, the mechanical strength can be prevented from being lowered, and excellent compression-resisting properties and shear-resisting properties can be secured, wherein a tightening force of the coarse screw thread portion can be maintained at a high level and the bolt can be repeatedly used.

The bolt according to the fifth aspect of the invention is a bolt as set forth in any one of the first through fourth aspect of the invention and has a construction in which the winding direction of a ridge of the above-described coarse screw thread portion is different from that of the above-described fine screw thread portion.

With such a construction, the following actions can be brought about in addition to those described in any one of the first through fourth aspect of the invention.

(1) Since the loosening direction (turning direction) of a nut screwed in a fine screw thread portion is different from the loosening direction (turning direction) of a nut screwed in a coarse screw thread portion, these nuts do not turn in the same direction, wherein the nuts are scarcely loosened, an intense tightening force can be secured, and excellent safety can be brought about.

A method for manufacturing a bolt according to the sixth aspect of the invention comprises the steps of: forming a coarse screw thread portion of pitch P by cutting or rolling a bolt shank from its tip end portion to a prescribed portion; and forming a fine screw thread portion of pitch p (p=P/n wherein n is an integer of 2 or more) by cutting or rolling the fine screw thread portion so as to overlap the above-described coarse screw thread portion at least the entire length of the above-described coarse screw thread portion of the above-described bolt shank or from the tip end portion of the above-described bolt shank to a prescribed portion of the above-described coarse screw thread portion.

With such a construction, the following actions can be brought about.

(1) Since a coarse screw thread portion and fine screw thread portion are formed by only two processes (step for forming a coarse screw thread portion and step for forming a fine screw thread portion), production costs are lowered, and mass production is enabled, wherein productivity thereof is excellent.

(2) Where a fine screw thread portion and a coarse screw thread portion are formed by cutting using a milling machine or a lathe, etc., since the pitch P is equivalent to integral number times of the pitch p, it is possible to easily calculate feed rates of dies or bolt matrices and easily set these parameters, wherein excellent productivity can be brought about.

(3) Where a fine screw thread portion and a coarse screw thread portion are formed by rolling using a rolling machine, etc., since the pitch P is equivalent to integral number times of the pitch p, the pitch of a rolling die to be used can be easily determined, wherein excellent productivity thereof can be secured.

(4) Where a fine screw thread portion is formed by rolling using a rolling machine, etc., since the pitch P is equivalent to integral number times of the pitch p, there is no case where the ridges of the coarse screw thread portion are locally crumbled and the ridge portion does not invade the root portion adjacent thereto. Therefore, it is possible to improve the yield ratio and to secure excellent productivity.

(5) Where a fine screw thread portion is formed by using a hand-turning type die so as to overlap the coarse screw thread portion formed by rolling or cutting, since the pitch P is equivalent to integral number times of the pitch p, the pitch of a hand-turning type die used can be easily determined, and excellent productivity can be secured.

(6) Since the pitch P is equivalent to integral number times of the pitch p and the cut positions of fine screw thread portions at the coarse screw thread portions appear on the same linear position at the same intervals, it is possible to detect a defective due to a die, etc. In addition, quality control can be easily carried out, wherein excellent productivity can be secured, and the yield ratio can be improved.

(7) Since the relationship between the pitch of the coarse screw thread portion and that of the fine screw thread portion is of integral number times regardless of the size of a bolt even if the size thereof is altered, fine pitches regularly appear, and excellent mechanical strength can be secured.

(8) Since the pitch P of the coarse screw thread portion is equivalent to integral number times of 2 or more of the pitch p of the fine screw thread portion, the same pattern of the fine screw thread portion can be formed per ridge of the coarse screw thread portion, and periodicity can be secured by repetition of the pattern. Therefore, since parts reduced by the formation of fine screw thread portions at ridges of coarse screw thread portions periodically exist, mechanical strength can be effectively prevented from being lowered due to local thinning of the ridges of the coarse screw thread portion, and stress concentration can be effectively prevented from occurring due to irregular formation of root portions of fine screw thread portions at ridges of the coarse screw thread portion, wherein it is possible to manufacture bolts whose durability can be maintained.

(9) It is possible to tighten a bolt, a coarse nut and a fine nut by screwing the fine nut in the fine screw thread portion so as to overlap the coarse nut after the coarse nut is screwed in the coarse screw thread portion of a bolt. At this time, if the fine nut and coarse nut are turned together, a repulsion force and a friction force operate on the contacting face (bearing surface) between both nuts since the pitch of the fine nut differs from that of the coarse nut, and the coarse nut can be prevented from turning in the loosening direction. Then, reliability in the equipment to which the bolt is applied can be increased.

(10) Since a recessed and projected pattern having periodicity is formed at the screw thread portion of a bolt, it is possible to carry out visual checks with respect to defective bolts by observing the pattern and to simply judge the periodicity by analyzing a bolt image picked up by a television camera, etc., where in it is possible to mass-produce bolts for which inspection can be efficiently carried out.

(11) Since the root portions (parts cut off when the root portions of fine screw thread portions are formed, in the ridges of the coarse screw thread portions) of fine screw thread portions at ridges of the coarse screw thread portions regularly exist in the axial direction of the bolt shank, it is possible to manufacture bolts whose appearance is excellent and commercial value can be increased.

(12) Since the root portions (parts cut off when the root portions of fine screw thread portions are formed, in the ridges of the coarse screw thread portions) of fine screw thread portions at the ridges of the coarse screw thread portions regularly exist in the axial direction of the bolt shank, pressure can be uniformly applied when being tightened by a nut. Therefore, the screw threads (ridges) are not crumbled or chipped. Further, tightening and removing operations thereof can be smoothly carried out, wherein it is possible to manufacture bolts for which usability is excellent.

Herein, a rolling machine, a lathe, milling machine, a mechanical-drive type or hand-drive type die, etc., may be used as means for forming coarse screw thread portions and fine screw thread portions.

The method for manufacturing a bolt according to the seventh aspect of the invention comprises the step of simultaneously form rolling coarse screw thread portions of pitch P, which are formed from the tip end portion of the bolt shank to a prescribed portion thereof, and fine screw thread portions of pitch p (p=P/n wherein n is an integer of 2 or more), which is formed at least the entire length of the coarse screw thread of the bolt shank or from the tip end portion to the prescribed portion of the coarse screw thread portion so as to overlap the coarse screw thread portions.

With such a construction, the following actions can be brought about in addition to those described from (6) through (12) in the sixth aspect.

(1) Since both coarse screw threads and fine screw threads are simultaneously formed by only a single process (rolling step), mass-production is enabled at low cost, and excellent productivity is brought about.

(2) Since the pitch P is equivalent to integral number times of the pitch p, it is possible to easily design and produce a rolling die.

Herein, a method using a flat die and method using a roll die may be listed as the rolling method.

A profile (shape) in which a coarse screw thread portion is formed on one of the dies opposed to each other and a fine screw thread portion is formed on the other thereof, and a profile (shape) in which a coarse screw thread portion and a fine screw thread portion are formed on both the dies opposed to each other may be listed as the profile of a flat and a roll die.

The method according to the eighth aspect of the invention is a method for manufacturing a bolt as set forth in the sixth or seventh aspect of the invention and includes a construction by which the pitch p of the above-described fine screw thread portions formed in the step of forming the fine screw thread portions or in the rolling step is formed to one half (½) times of the pitch P of the above-described coarse screw thread portions formed in the step of forming the coarse screw thread portions or in the rolling step.

With such a construction, the following actions can be brought about in addition to those described in the sixth or the seventh aspect of the invention.

(1) In comparison with a case where the pitch p of the fine screw thread portion is less than ½ times (for example, ⅓ times or ¼ times) the pitch P of the coarse screw thread portion, the surface area of a female screw thread portion of a fine nut, which is brought into contact with a male screw thread portion of a fine screw thread portion, is larger when the fine nut is screwed in the fine screw thread portion, whereby it is possible to maintain a tightening force between the fine screw thread portion and the fine nut at a high level, and at the same time, since the number of roots of the fine screw thread portion is a few, tightening and removing operations thereof can be smoothly carried out, and it is possible to manufacture bolts whose usability is excellent.

(2) Since the pitch P is two times the pitch P, it is possible to further easily determine a die to be used, calculate and set the feed rates of the dies and bolt matrices, design and produce the rolling dies and detect defectives of bolts, wherein quality control is facilitated, excellent productivity can be brought about, and the yield ratio thereof can be improved.

The method according to the ninth aspect of the invention is a method for manufacturing a bolt according to any one of the sixth aspect through eighth aspect of the invention, and includes a construction in which the lead angle β of the above-described fine screw thread portions formed in the above-described step of forming fine screw thread portions or rolling step is formed to be smaller than the lead angle αof the above-described coarse screw thread portions formed in the above-described step of forming coarse screw thread portions or rolling step.

With such a construction, the following actions can be brought about in addition to those described in any one of the sixth aspect through eighth aspect.

(1) Since the lead angle β of the fine screw thread portions is smaller than the lead angle α of the coarse screw thread portions where a fine nut is screwed in the fine screw thread portions after a coarse nut is screwed in the coarse screw thread portions, the movement distance of the fine nut with respect to the same turning angle becomes smaller than that of the coarse nut. Therefore, even if the coarse nut is turned in the loosening direction and is about to be separated from a member to be tightened, the fine nut is not able to move over the distance of the coarse nut with the same turning angle, wherein the coarse nut is prevented by the fine nut from turning in its loosening direction at all times, and it is possible to manufacture bolts that are scarcely loosened.

The method as set forth in the tenth aspect of the invention is a method for manufacturing a bolt as set forth in any one of the sixth aspect through ninth aspect of the invention, and includes a construction in which the root diameter D (the diameter of a hypothetical cylinder brought into contact with the root bottom coaxially with the above-described bolt shank) of the above-described coarse screw thread portion formed in the above-described step of forming coarse screw thread portions or rolling step is smaller than the root diameter d of the above-described fine screw thread portion formed in the above-described step of forming fine screw thread portions or rolling step.

With such a construction, the following actions can be brought about in addition to those described in any one of the sixth aspect through ninth aspect of the invention.

(1) Since the root bottom portion (cut-off part of the ridges of coarse screw thread portions) can be made shallow, the amount of cut-off can be reduced, and excellent mass-production and workability can be brought about.

(2) Since the root bottom portion (cut-off part of the ridges of coarse screw thread portions) can be made shallow, and parts reduced by cutting off the ridges of the coarse screw thread portions are slight even if the root bottom portions of the fine screw thread portions overlap the ridges of the coarse screw thread portions, excellent durability is secured, and the tightening force of the coarse screw thread portions can be maintained at a high level, wherein bolts which can be repeatedly used are able to be manufactured.

The method according to the eleventh aspect of the invention is a method for manufacturing a bolt as set forth in any one of the sixth aspect through tenth aspect and includes a construction in which the winding direction of the above-described coarse screw thread portions formed in the above-described step of forming coarse screw thread portions or rolling step and that of the above-described fine screw thread portions formed in the above-described step of forming fine screw thread portions or rolling step are formed so as to differ from each other.

With such a construction, the following actions can be brought about in addition to those described in any one of the sixth aspect through tenth aspect of the invention.

(1) Since the loosening direction (turning direction) of a nut screwed in fine screw thread portions is different from the loosening direction (turning direction) of a nut screwed in coarse screw thread portions, these nuts are not turned in the same direction together, wherein it is possible to manufacture bolts, having an intense tightening force and excellent safety, at which almost no loosening occurs.

### BRIEF DESCRIPTION OF THE DRAWINGS

FIG. 1 is a side elevational view of the major parts of a bolt according to Embodiment 1 of the invention;

FIG. 2 is an enlarged view of the major parts of a bolt shank according to Embodiment 1 of the invention;

FIG. 3 is a side elevational view of the major parts showing a use state of a bolt according to Embodiment 1 of the invention;

FIG. 4(a) is an enlarged view of part A in FIG. 3;

FIG. 4(b) is an enlarged view of part B in FIG. 3;

FIG. 5(a) is a view describing a state where coarse screw thread portions are being formed by cutting;

FIG. 5(b) is a view describing a state where fine screw thread portions are being formed by cutting;

FIG. 6 is a view describing a method for manufacturing a bolt according to Embodiment 2 of the invention;

FIG. 7(a) is a plan view observed from the coarse screw thread portion side of a coarse flat die;

FIG. 7(b) is a sectional view showing the major parts taken along the line C-C in FIG. 7(a);

FIG. 8(a) is a plan view observed from the fine screw thread portion side of a fine flat die;

FIG. 8(b) is a sectional view showing the major parts taken along the line D-D in FIG. 8(a);

FIG. 9 is a view describing a method for manufacturing a bolt according to Embodiment 3 of the invention;

FIG. 10 is a side elevational view of the major parts of a bolt manufactured according to Example 1; and

FIG. 11 is a side elevational view of the major parts of a bolt manufactured according to Comparison Control 1;

### BEST MODE FOR CARRYING OUT THE INVENTION

A description is given of a bolt and a method for manufacturing the same bolt according to embodiments of the invention, with reference to the accompanying drawings.

(Embodiment 1)

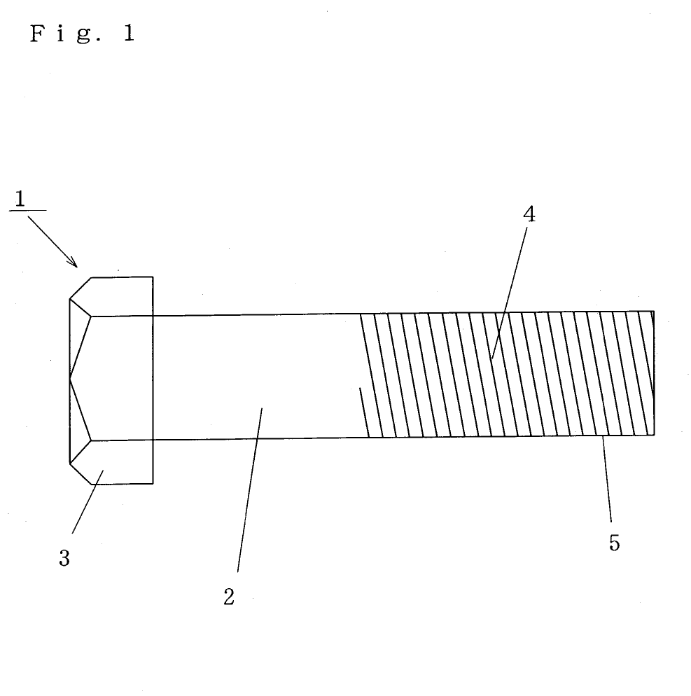

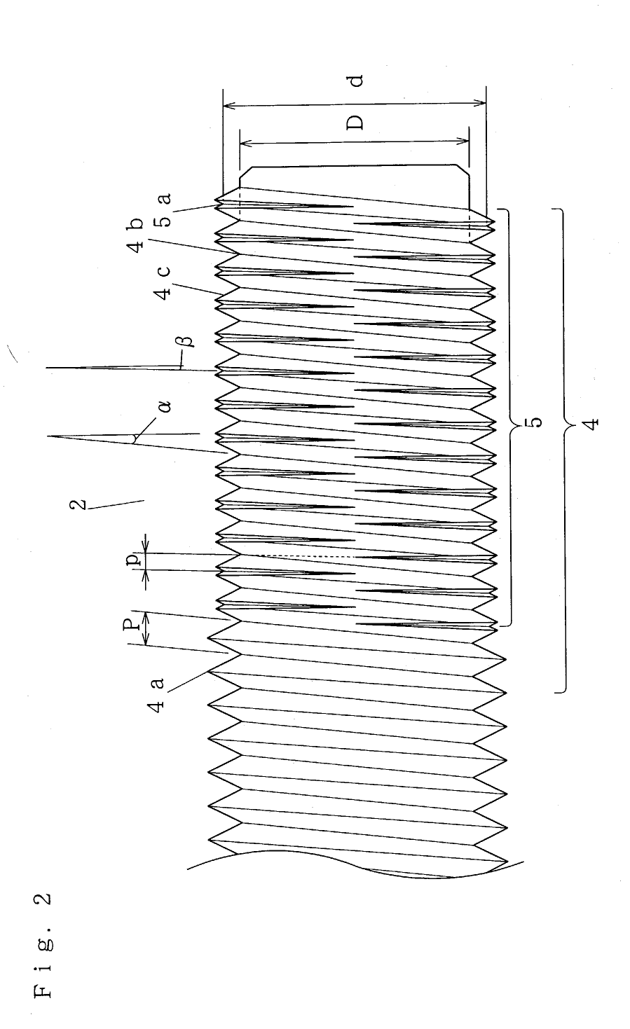

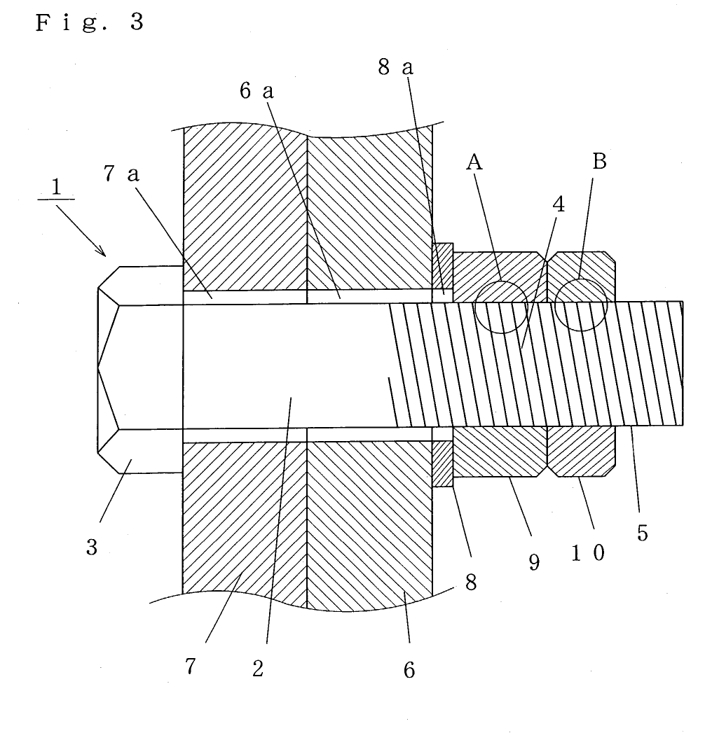

FIG. 1 is a side elevational view of the major parts of a bolt according to Embodiment 1 of the invention, FIG. 2 is an enlarged view of the major parts of a bolt shank, and FIG. 3 is a side elevational view of the major parts showing a use state of a bolt.

In FIG. 1 through FIG. 3, reference number 1 denotes a bolt according to Embodiment 1, 2 denotes the bolt shank of the bolt 1, 3 denotes the bolt head portion of the bolt 1 formed by cold forging, etc. A coarse screw thread portion 4 is formed from the tip end portion of the bolt shank 2 to a prescribed portion by cutting or rolling at pitch P, lead angle α, and root diameter D (the diameter of a hypothetical cylinder brought into contact with the root bottom portion coaxially with the bolt shank 2), and with a single start, wherein 4a denotes the top portion of a screw thread (ridge) of the coarse screw thread portion 4, 4b denotes the root bottom portion of the coarse screw thread portion 4, and 4c denotes the flank of the coarse screw thread portion 4. A fine screw thread portion 5 is formed from the tip end portion of the bolt shank 2 to a prescribed portion of the coarse screw thread portion 4 by cutting or rolling at pitch p, lead angle β, and root diameter d and with a single start, wherein 5a denotes the root bottom portion of the fine screw thread portion 5. Herein, the pitch p is ½ times the pitch P, the lead angle β is smaller than the lead angle α, and the root diameter D is smaller than the root diameter d.

Reference number 6 denotes a first member to be tightened, and 7 denotes a second member to be tightened, which is tightened to the member 6 by the bolt 1. The bolt 1 is inserted into and passed through bolt holes 6a and 7a of the first member 6 and the second member 7. A washer 8 is brought into contact with the first member 6 with the tip end portion side of the bolt 1 passed through a bolt hole 8a. A coarse nut 9 is screwed in the coarse screw thread portion 4 of the bolt 1, in which a female screw thread of pitch P is formed. A fine nut 10 is screwed in the fine screw thread portion 5 of the bolt 1, in which a female screw thread of pitch p is formed.

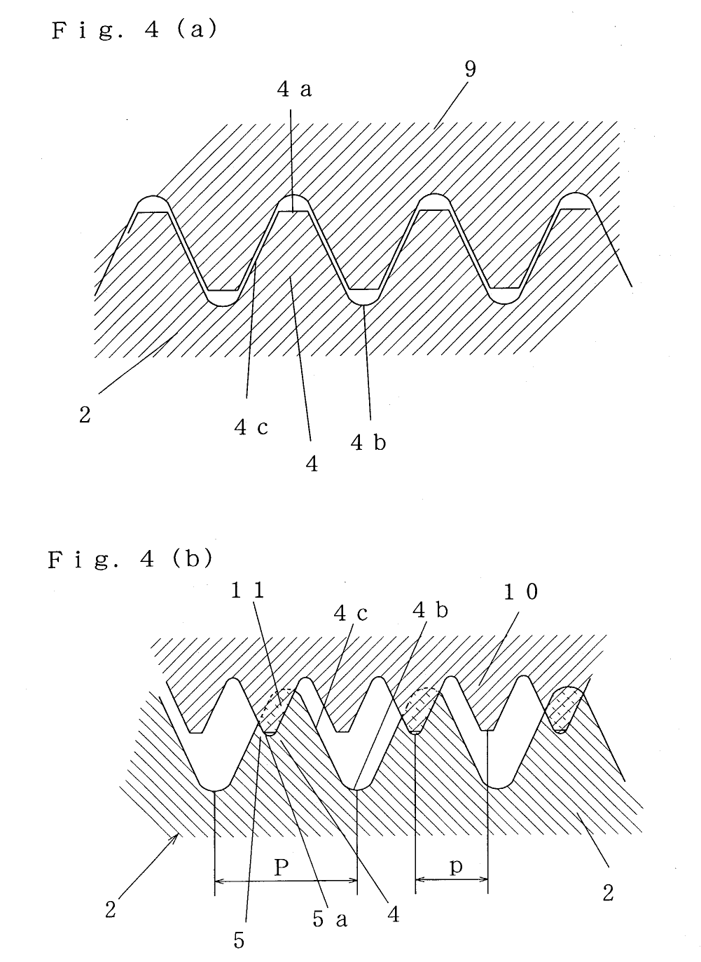

FIG. 4(a) is an enlarged view of part A in FIG. 3, and FIG. 4(b) is an enlarged view of part B in FIG. 3.

In FIG. 4, reference number 2 denotes a bolt shank, and 4 denotes a coarse screw thread portion where no fine screw thread portion is formed, wherein 4a denotes the top portion of a screw thread (ridge) of the coarse screw thread portion 4, 4b denotes the root bottom portion of the coarse screw thread portion 4, and 4c denotes the flank of the coarse screw thread portion 4. 5 denotes a fine screw thread portion formed so as to overlap the coarse screw thread portion 4, wherein 5a denotes the root bottom portion of the fine screw thread portion 5. 9 denotes a coarse nut, 10 denotes a fine nut, P denotes the pitch of the coarse screw thread portion 4, and p denotes the pitch of the fine screw thread portion 5. These are similar to those in FIG. 1 through FIG. 3, and are given the same reference numbers, wherein description thereof is omitted.

A part 11 is cut off from a part of the coarse screw thread portion 4 by a rolling apparatus, a lathe, a milling machine, a hand-turning type die, etc., in order to form a fine screw thread portion 5.

A description is given of a method for manufacturing the bolt constructed as described above according to Embodiment 1 , with reference to the accompanying drawings.

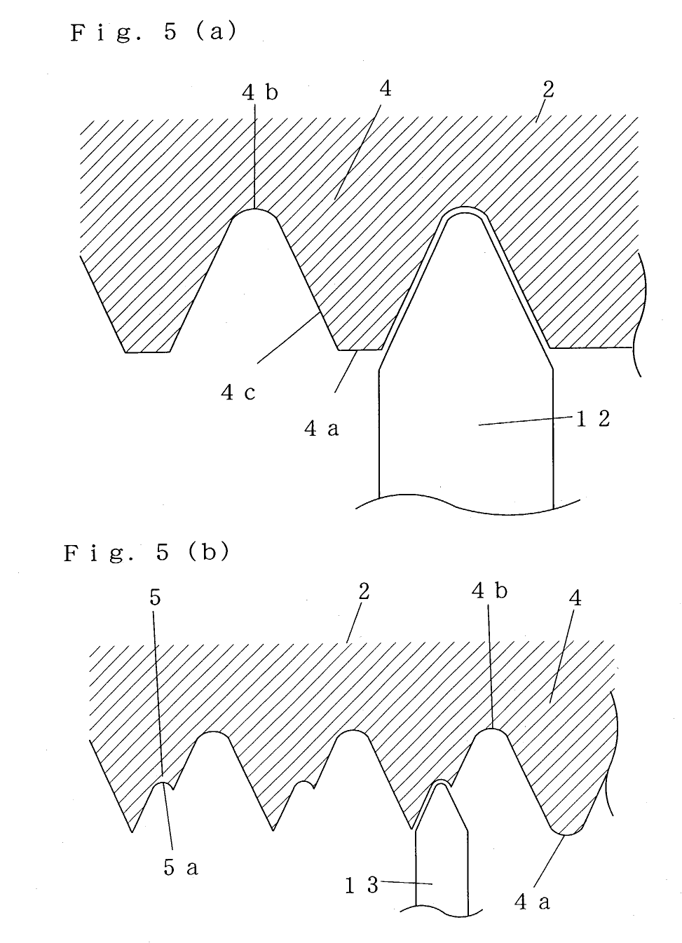

FIG. 5(a) is a view describing a state where coarse screw thread portions are being formed by cutting, and FIG. 5(b) is a view describing a state where fine screw thread portions are being formed by cutting.

In FIG. 5, reference number 2 denotes a bolt shank, 4 denotes a coarse screw thread portion, wherein 4a denotes the top portion of the coarse screw thread portion, 4b denotes a root bottom portion of the coarse screw thread portion, and 4c denotes the flank of the coarse screw thread portion. And, 5 denotes a fine screw thread portion, wherein 5a denotes the root bottom portion of the fine screw thread portion. These are similar to those in FIG. 4, and are given the same reference numbers, wherein description thereof is omitted.

A tool bit 12 for cutting coarse screw thread portions is attached to a lathe (not illustrated), and a tool bit 13 for cutting fine screw thread portions is attached to a lathe.

In order to manufacture a bolt 1, first, the bolt shank 2 is attached to a lathe and is moved in the axial direction while turning the bolt shank 2, whereby coarse screw thread portions 4 are formed by the side of the bolt shank 2 being cut off by the tool bit 12 for cutting coarse screw thread portions (Step of forming coarse screw thread portions). Next, the tool bit 13 for cutting fine screw thread portions are attached to a lathe, and a columnar material having coarse screw thread portions 4 formed is moved in the axial direction while turning it, wherein the parts 11 (See FIG. 4(b)) cutoff from the coarse screw thread portions 4 are removed, and a bolt 1 having fine screw thread portions 5 formed is manufactured (Step of forming fine screw thread portions).

Since a bolt and a method for manufacturing the same according to Embodiment 1 are constructed as described above, the following actions can be brought about.

(1) Since the pitch P of the coarse screw thread portion 4 becomes equivalent to 2 times of the pitch p of the fine screw thread portion 5, the same pattern of the fine screw thread portion 5 is formed per pitch at a ridge of the coarse screw thread portion 4, and periodicity due to repetition of the pattern is secured, wherein, since parts cut off by formation of the fine screw thread portion 5 at ridges of the coarse screw thread portion 4 periodically exist, it is possible to effectively prevent the mechanical strength from being lowered due to local thinning of the ridges of the coarse screw thread portion 4 and the stress from being concentrated due to irregular formation of root portions of the fine screw thread portion 5 on the ridges of the coarse screw thread portion 4, whereby durability of the bolt 1 can be maintained.

(2) A fine nut 10 can be screwed in the fine screw thread portion 5 of a bolt 1 so as to overlap a coarse nut 9 after the coarse nut 9 is screwed in the coarse screw thread portion 4 of the bolt 1, whereby the bolt 1 and both the nuts 9 and 10 can be tightened. At this time, if the fine nut 10 and coarse nut 9 are turned together, a repulsion force and a friction force operate on the contacting face (bearing surface) between both nuts 9 and 10 since the pitch of the fine nut 10 differs from that of the coarse nut 9, the coarse nut 9 can be prevented from turning in its loosening direction. Reliability in the equipment to which the bolt 1 is applied can be increased.

(3) Since a recessed and projected pattern having periodicity is formed at the bolt shank 2, it is possible to carry out visual checks with respect to defective bolts by observing the pattern and to judge the periodicity by analyzing a bolt image picked up by a television camera, etc., wherein it is possible to efficiently treat inspections of bolts 1 mass-produced.

(4) Since the root portions (parts cut off when the root portions of the fine screw thread portion 5 are formed in the ridges of the coarse screw thread portion 4) of the fine screw thread portion 5 at the ridges of the coarse screw thread portion 4 regularly exist in the axial direction of the bolt shank 2, the bolt 1 has excellent appearance, wherein the commercial value of bolts 1 can be increased.

(5) Since the root portions (parts cut off when the root portions of the fine screw thread portion 5 are formed in the ridges of the coarse screw thread portion 4) of the fine screw thread portion 5 at the ridges of the coarse screw thread portion 4 regularly exist in the axial direction of the bolt shank 2, pressure is uniformly applied when being tightened by a nut, whereby the screw threads (ridges) are prevented from being crumbled or chipped, and further tightening and removing operations can be smoothly carried out. That is, excellent usability can be secured.

(6) In comparison with a case where the pitch p of the fine screw thread portion 5 is less than ½ times (for example, ⅓ times or ¼ times) the pitch P of the coarse screw thread portion 4, it is possible to increase the surface area of a female screw thread portion of a fine nut 10, which is brought into contact with a male screw thread portion of a fine screw thread portion 5 when the fine nut 10 is screwed in the fine screw thread portion 5, whereby it is possible to maintain a tightening force between the fine screw thread portion 5 and the fine nut 10 at a high level, and at the same time, since the number of roots of the fine screw thread portion 5 are a few, tightening and removing operations thereof can be smoothly carried out, and excellent workability can be secured.

(7) Since the lead angle β of the fine screw thread portion 5 is smaller than the lead angle α of the coarse screw thread portion 4, the movement distance of the fine nut 10 with respect to the same turning angle is made smaller than that of the coarse nut 9. Therefore, even if the coarse nut 9 is turned in the loosening direction and is about to be separated from the first member 6 to be tightened, the fine nut 10 cannot move faster than the coarse nut 9, wherein the coarse nut 9 is always prevented by the fine nut 10 from being turned in the loosening direction, and is scarcely loosened.

(8) Since the root bottom portion 5a (part 11 where the ridge of the coarse screw thread portion 4 is cut off) of the fine screw thread portion 5 is shallow in comparison with the root bottom portion 4b of the coarse screw thread portion 4, and the reducing amount of the ridge of the coarse screw thread portion 4 is slight even if the root bottom portion 5a of the fine screw thread portion 5 overlaps the ridge of the coarse screw thread portion 4, excellent durability can be secured, and a tightening force of a coarse screw thread portion 4 can be maintained at a high level and the bolt can be repeatedly used.

(9) Since a coarse screw thread portion 4 and a fine screw thread portion 5 are formed by only two processes (step for forming a coarse screw thread portion and step for forming a fine screw thread portion), production costs are lowered, and mass production is enabled, wherein operation efficiency is excellent.

(10) Since the pitch P is equal to two times the pitch p, it is possible to easily determine dies used, easily calculate and set feed rates of the dies and bolt matrices, easily design and produce the rolling dies, and easily detect defectives. Quality can be easily controlled, and excellent productivity can be secured, wherein the yield ratio thereof can be improved.

Also, in Embodiment 1, although a bolt 1 is manufactured by a lathe, a milling machine may be used to manufacture the bolt 1.

Further, in Embodiment 1, although a fine screw thread portion 5 is formed from the tip end portion of the bolt shank 2 to a prescribed portion of the coarse screw thread portion 4, it is preferable that, where the fine screw thread portion 5 is formed on the entire length of the coarse screw thread portion 4, there is no limitation in the place for the fine nut 10 to be screwed in.

In addition, in Embodiment 1, although the coarse screw thread portion 4 and fine screw thread portion 5 are composed of a single start, any number of starts of the fine screw thread portion 5 may be applicable if it is less than the number of starts of the coarse screw thread portion 4.

Further, in Embodiment 1, although a triangular screw thread is used as the sectional shape of a screw thread (ridge), it is understood that a trapezoidal screw thread, square screw thread, serrated screw thread, round screw thread, etc., may be applicable.

Still further, in Embodiment 1, a description was given of a method for manufacturing a bolt in which the winding direction of the coarse screw thread portion 4 is the same as that of the fine screw thread portion 5. However, there may be a case where a bolt is manufactured in which the winding directions thereof differ from each other. In this case, since the loosening direction (turning direction) of a nut screwed in the fine screw thread portion is different from the loosening direction (turning direction) of a nut screwed in the coarse screw thread portion, the nuts are scarcely loosened, an intense tightening force and excellent safety can be secured.

Also, in Embodiment 1, a description was given of a case where a hexagonal bolt is manufactured. However, the embodiment is applicable to cases where a square bolt, eye bolt, round-headed bolt having a square root, flush bolt, wing bolt, anchor bolt, hexagonal socket-headed bolt, stud bolt, U bolt, etc., are manufactured.

(Embodiment 2)

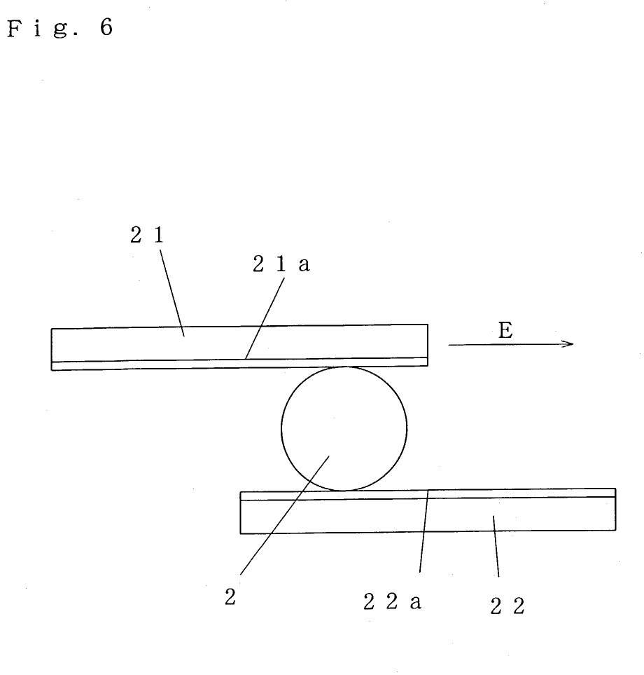

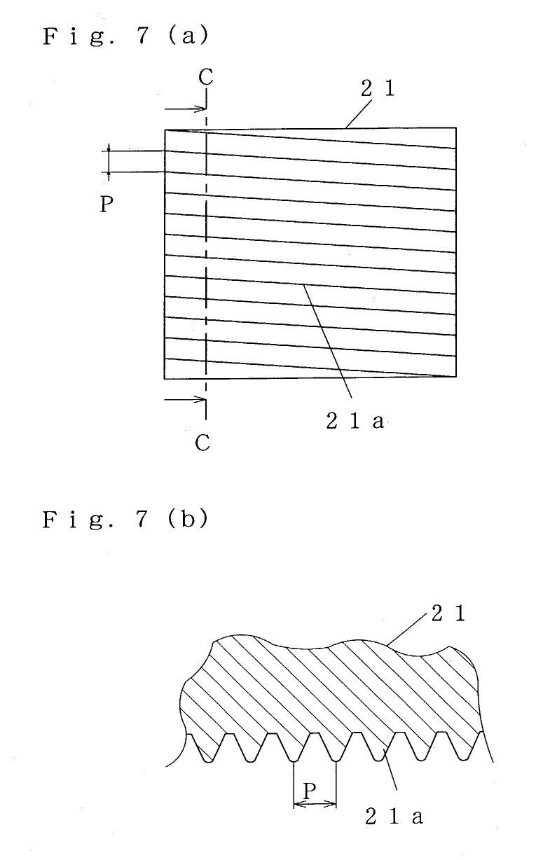

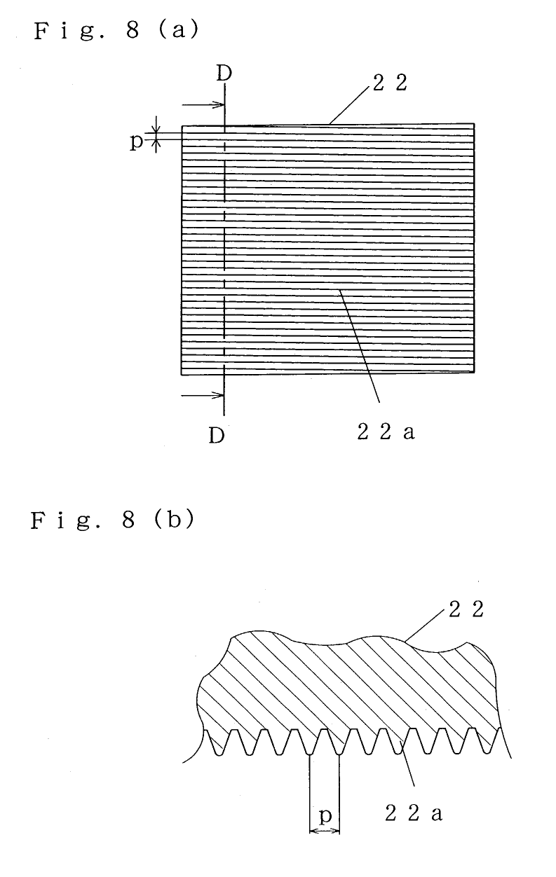

FIG. 6 is a view describing a method for manufacturing a bolt according to Embodiment 2 of the invention, FIG. 7(a) is a plan view observed from the coarse screw thread portion side of a coarse flat die, FIG. 7(b) is a sectional view showing the major parts taken along the line C-C in FIG. 7(a), FIG. 8(a) is a plan view observed from the fine screw thread portion side of a fine flat die, and FIG. 8(b) is a sectional view showing the major parts taken along the line D-D in FIG. 8(a).

Also, a bolt that is manufactured according to Embodiment 2 is similar to that of Embodiment 1, and description thereof is omitted.

In FIG. 6 through FIG. 8, reference number 2 denotes a bolt shank. The bolt shank is similar to that according to Embodiment 1, and description thereof is omitted.

A coarse flat die 21 has a coarse screw thread (ridge) 21a formed on the surface of a plate-like material, and a fine flat die 22 is disposed opposite to the coarse flat die 21 with a fixed interval secured therebetween and has a fine screw thread (ridge) 22a formed on the surface of a plate-like material. One of the coarse flat die 21 and fine flat die 22 is fixed while the other thereof is disposed so as to move in parallel thereto, or both are disposed so as to move in parallel in a direction opposite to each other.

In order to manufacture a bolt 1, in FIG. 6, if a bolt shank 2 is placed between the coarse flat die 21 and the fine flat die 22, and the coarse flat die 21 is moved in parallel to the fine flat die 22 in the direction of the arrow E (or the coarse flat die 21 and fine flat die 22 are moved in a direction opposite to each other), the bolt shank 2 is nipped between the coarse flat die 21 and fine flat die 22 and is caused to roll in the same direction as that of the coarse flat die 21 while causing a coarse screw thread portion and a fine screw thread portion to roll (Rolling step). Thereby, the bolt shank 2 is deformed through plasticity, wherein a bolt having a coarse screw thread portion and a fine screw thread portion formed on the outer circumferential surface can be manufactured.

Since a method for manufacturing a bolt according to Embodiment 2 is composed as described above, the following actions can be brought about in addition to those obtained by the method for manufacturing a bolt according to Embodiment 1.

(1) The coarse screw thread (ridge) 21a of the coarse flat die 21 and the fine screw thread (ridge) 22a of the fine flat die 22 are simultaneously transferred onto the bolt shank 2. Therefore, with only one process (rolling step), it is possible to form the coarse screw thread portion and fine screw thread portion. Mass production is enabled at low cost, and excellent workability can be secured.

Also, in Embodiment 2, separate dies on each of which the coarse screw thread (ridge) 2la and fine screw thread (ridge) 22a are separately formed are used. However, such an embodiment may be available, using a die on which the coarse screw thread (ridge) 21a and fine screw thread (ridge) 22a are formed integrally with each other may be used for rolling.

(Embodiment 3)

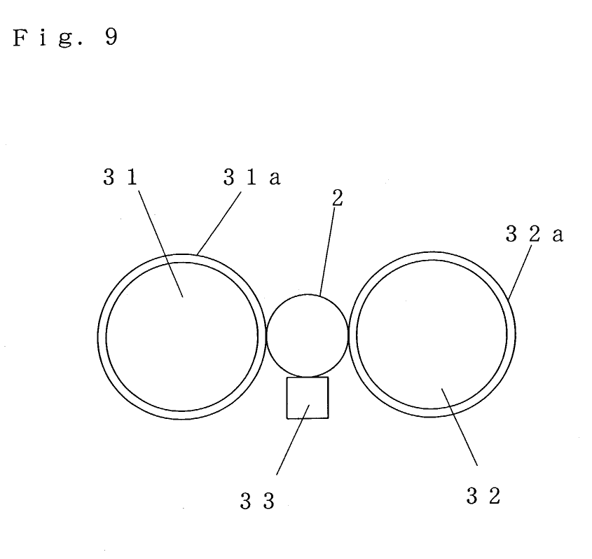

FIG. 9 is a view describing a method for manufacturing a bolt according to Embodiment 3 of the invention:

Further, a bolt manufactured according to Embodiment 3 is similar to that manufactured according to Embodiment 1, and description thereof is omitted.

In FIG. 9., reference number 2 denotes a bolt shank. Since the bolt shank 2 is similar to that of Embodiment 1, it is given the same reference number, and description thereof is omitted.

Reference number 31 denotes a coarse roll die having a coarse screw thread (ridge) 31a formed on its columnar surface, and 32 denotes a fine roll die having a fine screw thread (ridge) 32a formed on its columnar surface. A bolt shank supporting portion 33 is disposed between the coarse roll die 31 and the fine roll die 32, on which the bolt shank 2 is supported.

In order to manufacture a bolt 1, the bolt shank 2 is disposed on the bolt shank supporting portion 33 and is nipped between the coarse roll die 31 and the fine roll die 32, and the coarse roll die 31 and the fine roll die 32 are driven and turned. Thereby, the bolt shank 2 is nipped between the coarse roll die 31 and the fine roll die 32 and is caused to roll while being rolled by coarse screw thread portion 4 and a fine screw thread portion 5 (Rolling step). The rolled bolt shank 2 is deformed through plasticity, wherein a bolt having a coarse screw thread portion and a fine screw thread portion formed on its outer circumferential surface is manufactured.

Since the method for manufacturing a bolt according to Embodiment 3 is constructed as described above, the following actions can be brought about in addition to those obtained by the method for manufacturing a bolt according to Embodiment 1.

(1) A coarse screw thread (ridge) 31a of the coarse roll die 31 and a fine screw thread (ridge) 32a of the fine roll die 32 are simultaneously transferred onto the bolt shank 2, wherein since the coarse screw thread portion and fine screw thread portion are simultaneously formed by only one process (rolling step), mass-production is enabled at low cost, and excellent workability can be secured.

Also, in Embodiment 3, separate dies on each of which the coarse screw thread (ridge) 31a and fine screw thread (ridge) 32a are separately formed are used. However, such an embodiment may be available, using a die on which the coarse screw thread (ridge) and fine screw thread (ridge) are formed integrally with each other may be used.

### EXAMPLES

Hereinafter, a detailed description is given of the invention, using examples. Also, the invention is not limited to these examples.

### Example 1

A fine screw thread portion of pitch p=0.875 mm(p=P/2) was threaded on a bolt, having a coarse screw thread portion of pitch P=1.75 mm, whose outer diameter is 12 mm, by using a hand-turning type die.

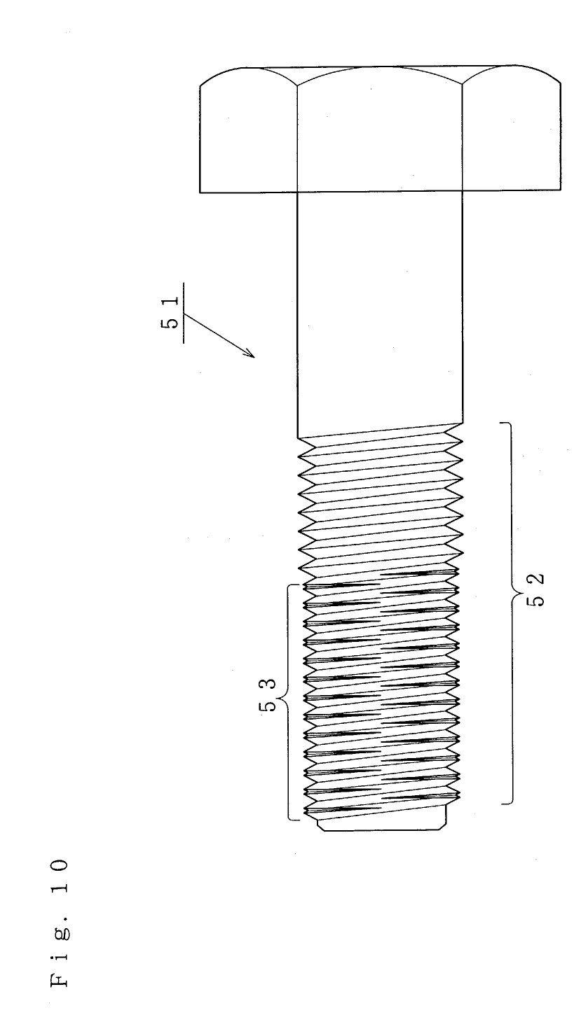

FIG. 10 is a side elevational view of the major parts of a bolt that is manufactured according to Example 1.

In FIG. 10, reference number 51 denotes a bolt manufactured by Example 1, 52 denotes a coarse screw thread portion of the bolt 51, and 53 denotes a fine screw thread portion threaded thereon.

As shown in FIG. 10, the fine screw thread portion 53 (root bottom portions thereof) is formed on the coarse screw thread portion 52 in good order and the appearance is favorable.

Next, the bolt sizes were variously altered, wherein if the relationship between the pitch of the coarse screw thread portion and the pitch of the fine screw thread portion is of integral number times regardless of the sizes of bolts, fine pitches are caused to regularly appear, and it is understood that the mechanical strength is excellent.

(Comparison Control 1)

Next, a fine screw thread portion of pitch p=1.0 mm was threaded on a bolt, having a coarse screw thread portion of pitch P=1.75 mm, whose outer diameter is 12 mm, by using a hand-turning type die.

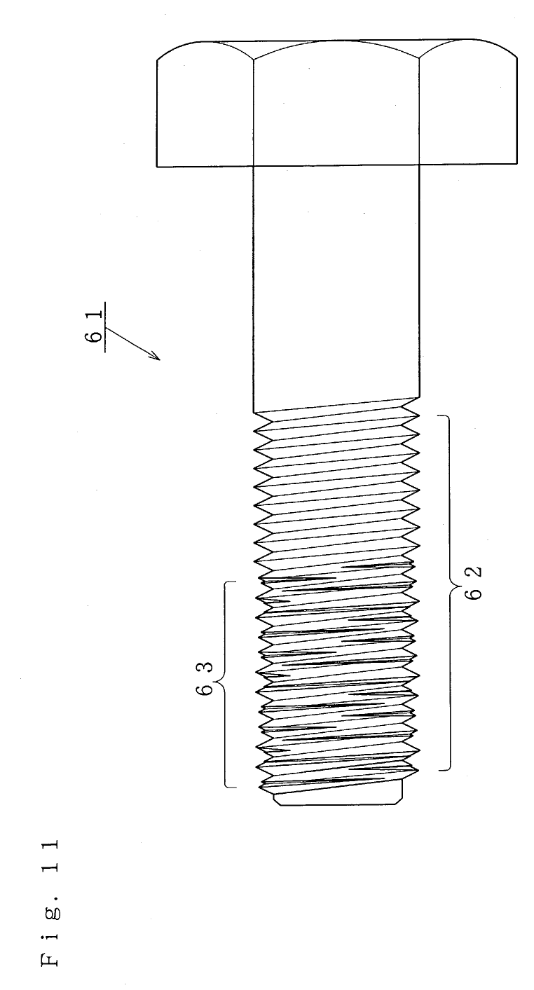

FIG. 11 is a side elevational view of the major parts of a bolt manufactured according to Comparison Control 1.

In FIG. 11, reference number 61 denotes a bolt manufactured according to Comparison Control 1, 62 denotes a coarse screw thread portion of the bolt 61, and 63 is a fine screw thread portion threaded thereon.

As shown in FIG. 11, the fine screw thread portion 63 is irregularly formed on the coarse screw thread portion 62, and there are points where screw threads (ridges) of the coarse screw thread portion 62 are remarkably cut off. That is, by only making the pitch p of the fine screw thread portion 63 smaller than the pitch P of the coarse screw thread portion as in Comparison Control 1, no regularity is brought about in the pattern of the fine screw thread portion 63 that is formed so as to overlap the coarse screw thread portion 62 per pitch, wherein a pattern like a wave is brought about on the outer diameter of the bolt, it is understood that no product having a commercial value is brought about. And, high screw threads (ridges) and low screw threads (ridges) are formed, wherein it is understood that loss of the mechanical strength is larger than that of the standard screw threads.

Industrial Applicability

As described above, a method for manufacturing a bolt according to the invention, the following advantageous effects can be brought about.

According to the first aspect;

(1) Since the pitch P of the coarse screw thread portion becomes equivalent to integral number times of 2 or more of the pitch p of the fine screw thread portion, the same pattern of the fine screw thread portion is formed per ridge of the coarse screw thread portion, and periodicity due to repetition of the pattern is secured, wherein, since parts reduced by formation of the fine screw thread portion at the ridges of the coarse screw thread portion periodically exist, it is possible to effectively prevent the mechanical strength from being lowered due to local thinning of the ridges of the coarse screw thread portion and the stress from being concentrated due to irregular formation of root portions of the fine screw thread portion on the ridges of the coarse screw thread portion, whereby durability of the bolt can be maintained.

(2) A fine nut can be screwed in the fine screw thread portion so as to overlap the coarse nut after a coarse nut is screwed in the coarse screw thread portion of the bolt, whereby the bolt and both the nuts can be tightened. At this time, if the fine nut and coarse nut are turned together, a repulsion force and a friction force operate on the contacting face (bearing surface) between both nuts since the pitch of the fine nut differs from that of the coarse nut, and backlash is corrected, wherein the coarse nut can be prevented from turning in its loosening direction. Reliability in the equipment to which the bolt is applied can be increased.

(3) Since a recessed and projected pattern having periodicity is formed at the screw thread portion of a bolt, the production can be facilitated and the yield ratio is high. Also, since it is possible to carry out visual checks with respect to defective bolts by observing the pattern and to simply judge the periodicity by analyzing a bolt image picked up by a television camera, etc., quality control can be facilitated, and it is possible to mass-produce high-quality bolts at low cost.

(4) Since the root portions (parts cut off when the root portions of the fine screw thread portion are formed in the ridges of the coarse screw thread portion) of the fine screw thread portion at the ridges of the coarse screw thread portion regularly exist in the axial direction of the bolt shank, the bolt has excellent appearance, and visual inspection can be easily carried out, wherein the commercial value of bolts can be increased.

(5) Since the root portions of the fine screw thread portion at the ridges of the coarse screw thread portion regularly exist in the axial direction of the bolt shank, pressure can be uniformly applied when tightening the bolt with nuts, wherein the ridges are free from being crumbled or chipped, and operating convenience can be secured since tightening and removing operations can be smoothly carried out.

Herein, a hexagonal bolt, square bolt, eye bolt, round-headed bolt having a square root, flush bolt, wing bolt, anchor bolt, hexagonal socket-headed bolt, etc., are used as bolts having a head portion, and a stud bolt, U bolt, etc., are used as bolts having a screw thread portion at both ends but not having any head portion.

According to the second aspect of the invention in addition to the effects described in the first aspect;

(1) In comparison with a case where the pitch p of the fine screw thread portion is less than ½ times (for example, ⅓ times or ¼ times) the pitch P of the coarse screw thread portion, it is possible to increase the surface area of a female screw thread portion of a fine nut, which is brought into contact with a male screw thread portion of a fine screw thread portion when the fine nut is screwed in the fine screw thread portion, whereby it is possible to maintain a tightening force between the fine screw thread portion and the fine nut at a high level, and at the same time, since the number of roots of the fine screw thread portion are a few, tightening and removing operations thereof can be smoothly carried out, and excellent workability can be secured.

According to the third aspect of the invention in addition to the effects described in the first or second aspect;

(1) Since the lead angle β of the fine screw thread portion is smaller than the lead angle α of the coarse screw thread portion where a fine nut is screwed in a fine screw thread portion after a coarse nut is screwed in a coarse screw thread portion, the movement distance of the fine nut with respect to the same turning angle is made smaller than that of the coarse nut. Therefore, even if the coarse nut is turned in the loosening direction and is about to be separated from a member to be tightened, the fine nut cannot move over the movement distance of the coarse nut with the same turning angle, wherein the coarse nut is prevented by the fine nut from being turned in the loosening direction, and is scarcely loosened.

According to the fourth aspect of the invention in addition to the effects described in any one of the first aspect through third aspect;

(1) Since the root bottom portion (part where the ridge of the coarse screw thread portion is cut off) of the fine screw thread portion is shallow, and the reducing amount of the ridge of the coarse screw thread portion is slight even if the root bottom portion of the fine screw thread portion overlaps the ridge of the coarse screw thread portion, the mechanical strength can be prevented from being lowered, and excellent compression-resisting properties and shear-resisting properties can be secured, wherein a tightening force of the coarse screw thread portion can be maintained at a high level and the bolt can be repeatedly used.

According to the fifth aspect of the invention, in addition to the effects described in any one of the first aspect through fourth aspect;

(1) Since the loosening direction (turning direction) of a nut screwed in a fine screw thread portion is different from the loosening direction (turning direction) of a nut screwed in a coarse screw thread portion, these nuts do not turn in the same direction, wherein the nuts are scarcely loosened, an intense tightening force can be secured, and excellent safety can be brought about.

According to the sixth aspect of the invention;

(1) Since a coarse screw thread portion and fine screw thread portion are formed by only two processes (step for forming a coarse screw thread portion and step for forming a fine screw thread portion), production costs are lowered, and mass production is enabled, wherein productivity thereof is excellent.

(2) Where a fine screw thread portion and a coarse screw thread portion are formed by cutting using a milling machine or a lathe, etc., since the pitch P is equivalent to integral number times of the pitch p, it is possible to easily calculate feed rates of dies or bolt matrices and easily set these parameters, wherein excellent productivity can be brought about.

(3) Where a fine screw thread portion and a coarse screw thread portion are formed by rolling using a rolling machine, etc., since the pitch P is equivalent to integral number times of the pitch p, the pitch of a rolling die to be used can be easily determined, wherein excellent productivity thereof can be secured.

(4) Where a fine screw thread portion is formed by rolling using a rolling machine, etc., since the pitch P is equivalent to integral number times of the pitch p, there is no case where the ridges of the coarse screw thread portion are locally crumbled and the ridge portion does not invade the root portion adjacent thereto. Therefore, it is possible to improve the yield ratio and to secure excellent productivity.

(5) Where a fine screw thread portion is formed by using a hand-turning type die so as to overlap the coarse screw thread portion formed by rolling or cutting, since the pitch P is equivalent to integral number times of the pitch p, the pitch of a hand-turning type die used can be easily determined, and excellent productivity can be secured.

(6) Since the pitch P is equivalent to integral number times of the pitch p and the cut positions of fine screw thread portions at the coarse screw thread portions appear on the same linear position at the same intervals, it is possible to detect a defective due to a die, etc. In addition, quality control can be easily carried out, wherein excellent productivity can be secured, and the yield ratio can be improved.

(7) Since the relationship between the pitch of the coarse screw thread portion and that of the fine screw thread portion is of integral number times regardless of the size of a bolt even if the size thereof is altered, fine pitches regularly appear, and excellent mechanical strength can be secured.

(8) Since the pitch P of the coarse screw thread portion is equivalent to integral number times of 2 or more of the pitch p of the fine screw thread portion, the same pattern of the fine screw thread portion can be formed per ridge of the coarse screw thread portion, and periodicity can be secured by repetition of the pattern. Therefore, since parts reduced by the formation of fine screw thread portions at ridges of coarse screw thread portions periodically exist, mechanical strength can be effectively prevented from being lowered due to local thinning of the ridges of the coarse screw thread portion, and stress concentration can be effectively prevented from occurring due to irregular formation of root portions of fine screw thread portions at ridges of the coarse screw thread portion, wherein it is possible to manufacture bolts whose durability can be maintained.

(9) It is possible to tighten a bolt, a coarse nut and a fine nut by screwing the fine nut in the fine screw thread portion so as to overlap the coarse nut after the coarse nut is screwed in the coarse screw thread portion of a bolt. At this time, if the fine nut and coarse nut are turned together, a repulsion force and a friction force operate on the contacting face (bearing surface) between both nuts since the pitch of the fine nut differs from that of the coarse nut, and the coarse nut can be prevented from turning in the loosening direction. Then, reliability in the equipment to which the bolt is applied can be increased.

(10) Since a recessed and projected pattern having periodicity is formed at the screw thread portion of a bolt, it is possible to carry out visual checks with respect to defective bolts by observing the pattern and to simply judge the periodicity by analyzing a bolt image picked up by a television camera, etc., wherein it is possible to mass-produce bolts for which inspection can be efficiently carried out.

(11) Since the root portions (parts cut off when the root portions of fine screw thread portions are formed, in the ridges of the coarse screw thread portions) of fine screw thread portions at the ridges of the coarse screw thread portions regularly exist in the axial direction of the bolt shank, it is possible to manufacture bolts whose appearance is excellent and commercial value can be increased.

(12) Since the root portions (parts cut off when the root portions of fine screw thread portions are formed, in the ridges of the coarse screw thread portions) of fine screw thread portions at the ridges of the coarse screw thread portions regularly exist in the axial direction of the bolt shank, pressure can be uniformly applied when being tightened by a nut. Therefore, the screw threads (ridges) are not crumbled or chipped. Further, tightening and removing operations thereof can be smoothly carried out, wherein it is possible to manufacture bolts for which usability is excellent.

According to the seventh aspect of the invention in addition to the effects described in (6) through (12) in the sixth aspect;

(1) Since both coarse screw threads and fine screw threads are simultaneously formed by only a single process (rolling step), mass-production is enabled at low cost, and excellent productivity is brought about.

(2) Since the pitch P is equivalent to integral number times of the pitch p, it is possible to easily design and produce a rolling die.

According to the eighth aspect of the invention, in addition to the effects described in the sixth aspect or the seventh aspect thereof;

(1) In comparison with a case where the pitch p of the fine screw thread portion is less than ½ times (for example, ⅓ times or ¼ times) the pitch P of the coarse screw thread portion, the surface area of a female screw thread portion of a fine nut, which is brought into contact with a male screw thread portion of a fine screw thread portion, is larger when the fine nut is screwed in the fine screw thread portion, whereby it is possible to maintain a tightening force between the fine screw thread portion and the fine nut at a high level, and at the same time, since the number of roots of the fine screw thread portion is a few, tightening and removing operations thereof can be smoothly carried out, and it is possible to manufacture bolts whose usability is excellent.

(2) Since the pitch P is two times the pitch P, it is possible to further easily determine a die to be used, calculate and set the feed rates of the dies and bolt matrices, design and produce the rolling dies and detect defectives of bolts, wherein quality control is facilitated, excellent productivity can be brought about, and the yield ratio thereof can be improved.

According to the ninth aspect of the invention, in addition to the effects described in any one of the sixth aspect through eighth aspect thereof;

(1) Since the lead angle β of the fine screw thread portions is smaller than the lead angle α of the coarse screw thread where a fine nut is screwed in the fine screw thread portions after a coarse nut is screwed in the coarse screw thread portions, the movement distance of the fine nut with respect to the same turning angle becomes smaller than that of the coarse nut. Therefore, even if the coarse nut is turned in the loosening direction and is about to be separated from a member to be tightened, the fine nut is not able to move over the distance of the coarse nut with the same turning angle, wherein the coarse nut is prevented by the fine nut from turning in its loosening direction at all times, and it is possible to manufacture bolts that are scarcely loosened.

According to the tenth aspect of the invention, in addition to the effects described in any one of the sixth aspect through ninth aspect thereof;

(1) Since the root bottom portion (cut-off part of the ridges of coarse screw thread portions) can be made shallow, the amount of cut-off can be reduced, and excellent mass-production and workability can be brought about.

(2) Since the root bottom portion (cut-off part of the ridges of coarse screw thread portions) can be made shallow, and parts reduced by cutting off the ridges of the coarse screw thread portions are slight even if the root bottom portions of the fine screw thread portions overlap the ridges of the coarse screw thread portions, excellent durability is secured, and the tightening force of the coarse screw thread portions can be maintained at a high level, wherein bolts which can be repeatedly used are able to be manufactured.

According to the eleventh aspect of the invention, in addition to the effects described in any one of the sixth aspect through tenth aspect thereof;

(1) Since the loosening direction (turning direction) of a nut screwed in fine screw thread portions is different from the loosening direction (turning direction) of a nut screwed in coarse screw thread portions, these nuts are not turned in the same direction together, wherein it is possible to manufacture bolts, having an intense tightening force and excellent safety, at which almost no loosening occurs.

What is claimed is:

1. A bolt comprising: a coarse screw thread portion of pitch P, which is formed from the tip end portion of a bolt shank to a prescribed portion; and a fine screw thread portion of pitch p (p=P/n wherein n is an integer of 2 or more), which is formed so as to overlap said coarse screw thread portion for at least the entire length of said coarse screw thread portion of said bolt shank or from the tip end portion to the prescribed portion of said coarse screw thread portion.

2. The bolt as set forth in claim 1, wherein said pitch p of said fine screw thread portion is one half said pitch P of said coarse screw thread portion.

3. The bolt as set forth in claim 1 or 2, wherein the lead angle β of said fine screw thread portion is smaller than the lead angle α of said coarse screw thread portion.

4. The bolt as set forth in any one of claims 1 through 3, wherein the root diameter D (the diameter of a hypothetical cylinder brought into contact with the root bottom coaxially with said bolt shank) of said coarse screw thread portion is smaller than the root diameter d of said fine screw thread portion.

5. The bolt according to any one of claims 1 through 4, wherein the winding direction of a ridge of said coarse screw thread portion is different from that of said fine screw thread portion.

6. A method for manufacturing a bolt comprising the steps of: forming a coarse screw thread portion of pitch P by cutting or rolling a bolt shank from its tip end portion to a prescribed portion; and forming a fine screw thread portion of pitch p (p=P/n wherein n is an integer of 2 or more) by cutting or rolling the fine screw thread portion so as to overlap said coarse screw thread portion at least the entire length of said coarse screw thread portion of said bolt shank or from the tip end portion of said bolt shank to a prescribed portion of said coarse screw thread portion.

7. A method for manufacturing a bolt comprising the step of: simultaneously form rolling coarse screw thread portions of pitch P, which are formed from the tip end portion of the bolt shank to a prescribed portion thereof, and fine screw thread portions of pitch p (p=P/n wherein n is an integer of 2 or more), which is formed at least the entire length of said coarse screw thread of said bolt shank or from the tip end portion to the prescribed portion of said coarse screw thread portion so as to overlap said coarse screw thread portions.

8. The method for manufacturing a bolt as set forth in claim 6 or 7 wherein the pitch p of said fine screw thread portions formed in said step of forming fine screw thread portions or in said rolling step is formed to one half (½) times of the pitch P of said coarse screw thread portions formed in said step of forming coarse screw thread portions or in said rolling step.

9. The method for manufacturing a bolt as set forth in any one of claims 6 through 8, wherein the lead angle β of said fine screw thread portions formed in said step of forming fine screw thread portions or rolling step is formed to be smaller than the lead angle α of said coarse screw thread portions formed in said step of forming coarse screw thread portions or rolling step.

10. The method for manufacturing a bolt as set forth in any one of claims 6 through 9, wherein the root diameter D (the diameter of a hypothetical cylinder brought into contact with the root bottom coaxially with said bolt shank) of said coarse screw thread portion formed in said step of forming coarse screw thread portions or rolling step is smaller than the root diameter d of said fine screw thread portion formed in said step of forming fine screw thread portions or rolling step.

11. The method for manufacturing a bolt as set forth in any one of claims 6 through 10, wherein the winding direction of said coarse screw thread portions formed in said step of forming coarse screw thread portions or rolling step and that of said fine screw thread portions formed in said step of forming fine screw thread portions or rolling step are formed so as to differ from each other.
